(19) United States
(12) Patent Application Publication
(10) Pub. No.: US 2006/0051144 A1
(43) Pub. Date: Mar. 9, 2006

(54) Scanner equipped printer and scanner

(75) Inventor: Yoshikazu Konishi, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/213,120

(22) Filed: Aug. 26, 2005

(30) Foreign Application Priority Data
Sep. 3, 2004 (JP) 2004-257470

(51) Int. Cl. G03G 15/00

(52) U.S. Cl. 399/380

(57) ABSTRACT

A scanner equipped printer includes the scanner's main body and the printer's main body. The scanner's main body has an upper portion provided with a cover having a side attached to a sheet feed tray and thus serving as an axis of pivotation to be capable of being opened and closed as desired to press downwards an original placed on the scanner. The cover is a flexible member formed for example of polypropylene. Furthermore the scanner's main body has an upper portion provided with a tray accommodating a sheet to be fed to the printer's main body. The cover and a guard member are integrally formed to prevent an object placed on the cover from falling toward the tray when the cover is opened. Thus the original can be prevented from displacing from a prescribed position when the cover is closed.

### BACKGROUND OF THE INVENTION

1. Field of the Invention

The present invention relates generally to scanner equipped printers and scanners and particularly to those having a cover pressing downward an original placed on the scanner's main body.

2. Description of the Background Art

Conventionally there exists a scanner equipped printer having a printer function printing information of images and the like with a scanner function added thereto to scan in information of originals. With reference to FIG. 7, a scanner equipped printer 101 of this type includes the scanner's main body 103 reading in information of an original, and the printer's main body 105 using the read information to print it. The scanner's main body 103 and the printer's main body 105 are integrated together and in particular as the original is placed on the scanner's main body 103 the printer's main body 105 underlies the scanner's main body 103.

The scanner's main body 103 has an upper portion with a tray 109 attached thereto to feed the printer's main body 105 with a sheet having a prescribed size. Furthermore the scanner's main body 103 also has an upper portion provided with a cover 107 having a side attached to tray 109 and serving as an axis of pivotation so that the cover can be opened and closed as desired to press downward the original placed on the scanner. Cover 107 is provided with a guard member 111 preventing an object placed on cover 107 from falling toward tray 109 when cover 107 is opened. The printer's main body 105 has a sheet output port 106 outputting a printed sheet.

Scanner equipped printer 101 described above operates as described hereinafter. With reference to FIG. 8, cover 107 is initially opened and an original (not shown) is placed at a prescribed location on a glass plate 104 disposed at an upper portion of the scanner's main body 103. Cover 107 is then closed and the scanner's main body 103 scans in the original's information. When the original's information is read completely, cover 107 is opened and the original is removed, and a subsequent sheet is placed on glass plate 104. A similar operation is repeated to read in the original's information successively.

The printer's main body 105 prints each read original's information on a sheet, and the printed sheet is output through sheet output port 106. The conventional scanner equipped printer is thus configured and operates. Conventional, cover equipped scanners are disclosed for example in Japanese Patent Laying-open Nos. 06-014139 and 2002-077485 and Japanese Utility Model Laying-open No. 63-059452.

Such conventional scanner equipped printers, however, have the following disadvantage: As has been described above, to read information of an original, cover 107 will be opened and the original will be placed at a prescribed position on glass plate 104 of the scanner's main body 103 and cover 107 will then be closed. Cover 107 is typically formed of high impact polystyrene and thus relatively hard. As such, when cover 107 is closed, wind pressure can be caused between cover 107 and the scanner's main body 103 and displace the original from the prescribed position. As a result the original's information may not be read as it is.

### SUMMARY OF THE INVENTION

The present invention has been made to overcome such disadvantage. One object of the present invention is to provide a scanner equipped printer preventing an original from displacing from a prescribed position when a cover is closed. Another object of the present invention is to provide such a scanner.

The present scanner equipped printer includes: a main body of the printer printing information of an original; a main body of the scanner overlying the printer's main body to bear the original thereon to read the information of the original; a cover provided to the scanner's main body and having one side serving as an axis and the other side pivoted around the axis to be capable of being opened and closed as desired to press downward the original placed on the scanner's main body; a tray disposed adjacent to the axis and accommodating a sheet to be fed to the printer's main body; and a guard member provided to the cover to prevent an object placed on the cover from falling toward the tray when the cover is opened. The cover is a flexible member and the cover and the guard member are integrally formed.

An original placed on the scanner's main body is covered with a cover formed of a flexible material. As such, when the cover is opened, the cover experiences gravity and thus will flex downward to protrude. As such, at an initial stage of closing the cover the original placed on the scanner's main body will have an end sandwiched between the cover and the scanner's main body. As a result if in closing the cover, wind pressure is caused between the cover and the scanner's main body, the original placed on the scanner's main body will not be displaced from the prescribed position and can reliably be read in. Furthermore, the cover with a guard member integrated therewith can contribute to a reduced number of components and hence reduced production cost as compared with providing a guard member implemented by a member separate from the cover.

The present scanner includes: a main body bearing an original thereon to read information of the original; and a cover attached to the main body to be capable of being opened and closed as desired to press downward the original placed on the main body. The cover is a flexible member.

When the cover formed of a flexible material is opened, the cover experiences gravity and thus will flex downward to protrude. As such, at an initial stage of closing the cover the original placed on the scanner's main body will have an end sandwiched between the cover and the scanner's main body. As a result if in closing the cover, wind pressure is caused between the cover and the scanner's main body, the original placed on the scanner's main body will not be displaced from the prescribed position and can reliably be read in.

Furthermore the scanner may further include a main body of a printer underlying the scanner's main body and having a function printing the information of the original scanned in by the scanner's main body.

The scanner may further include a guard member provided to the cover to prevent an object placed on the cover from falling when the cover is opened.

Furthermore, if the scanner further includes a tray accommodating a sheet to be fed to the printer's main body, the guard member is preferably arranged to prevent an object from falling toward the tray.

In particular, preferably, the cover and the guard member are integrally formed for production cost reduction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of the present scanner equipped printer in an embodiment.

FIG. 2 is a partial cross section in the embodiment, taken along a line II-II of FIG. 1.

FIG. 3 is a perspective view for illustrating the scanner equipped printer in the embodiment in operation with a cover open.

FIG. 4 is a partial cross section for illustrating the scanner equipped printer in the embodiment in operation assuming a position as shown in FIG. 3.

FIG. 5 is a partial cross section for illustrating the scanner equipped printer in the embodiment in operation assuming a position subsequent to that shown in FIG. 4.

FIG. 6 is a partial cross section for illustrating the scanner equipped printer in the embodiment in operation assuming a position subsequent to that shown in FIG. 5.

FIG. 7 is a perspective view of a conventional scanner equipped printer.

FIG. 8 is a perspective view for illustrating the conventional scanner equipped printer in operation with a cover open.

### DESCRIPTION OF THE PREFERRED EMBODIMENTS

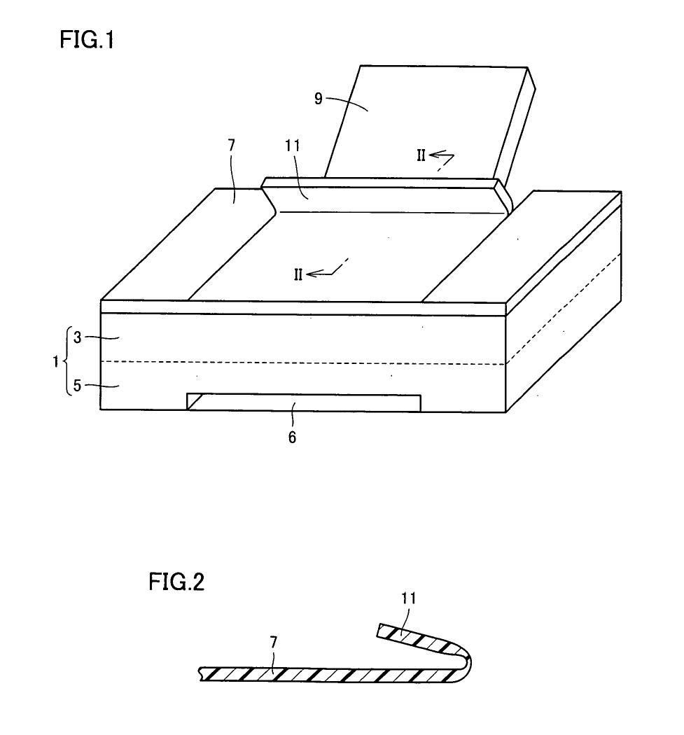

The present invention in an embodiment provides a scanner equipped printer as will be described hereinafter. With reference to FIG. 1, a scanner equipped printer 1 includes the scanner's main body 3 reading in information of an original, and the printer's main body 5 printing the read information. The printer's main body 5 underlies the scanner's main body 3 integrally. The scanner's main body 3 has an upper portion with a tray 9 attached thereto to feed the printer's main body 5 with a sheet having a prescribed size. Furthermore, the printer's main body 5 has a sheet output port 6 outputting a printed sheet.

The scanner's main body 3 has an upper portion provided with a cover 7 having a side attached to tray 9 and serving as an axis of pivotation so that the cover can be opened and closed as desired to press downward an original placed on the scanner. Cover 7 is formed of a flexible material such as polypropylene. Furthermore cover 7 is provided with a guard member 11 preventing an object placed on cover 7 from falling toward tray 9 when cover 7 is opened. Guard member 11 is integrated with cover 7, as shown in FIG. 2.

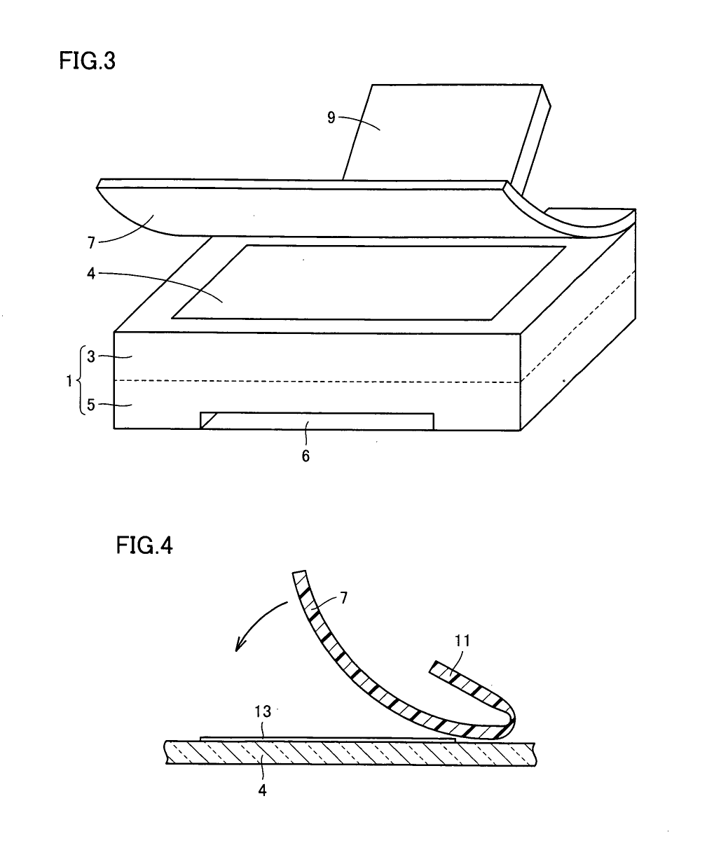

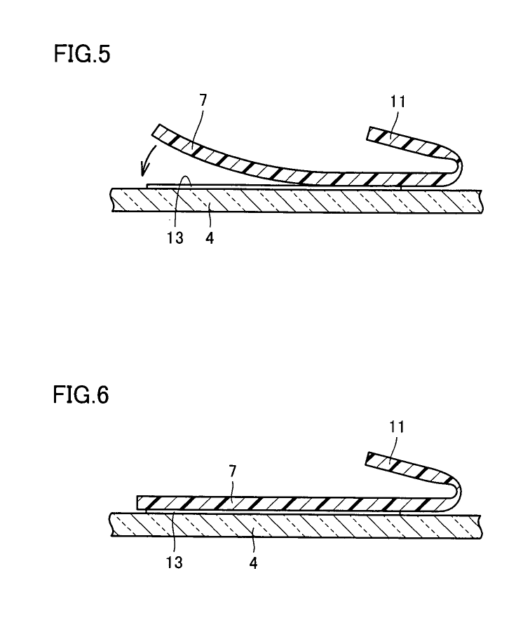

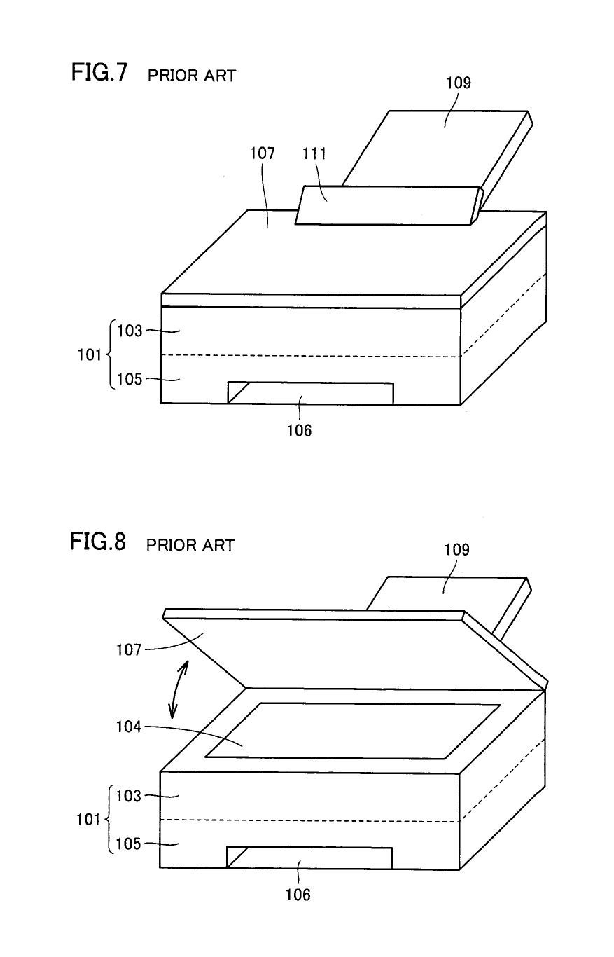

Scanner equipped printer 1 as described above operates, as described hereinafter. As shown in FIG. 3, initially cover 7 is opened to expose a glass plate 4 disposed at a top portion of the scanner's main body 3, and then, as shown in FIG. 4, an original 13 is placed on glass plate 4 at a prescribed position. Then, as shown in FIG. 5, cover 7 has one side gradually pulled down and, as shown in FIG. 6, cover 7 is completely closed to cover original 13. In this condition, the scanner's main body 3 reads in information of original 13. After the information of original 13 has completely been read, cover 7 is opened and original 13 is removed, and a subsequent original (not shown) is placed on glass plate 4 and the operation as described above is repeated to read in the original information successively.

Each read original's information scanned in by the scanner's main body 3 is printed by the printer's main body 5 on a sheet (not shown) fed from tray 9. The printed sheet is output through sheet output port 6.

For scanner equipped printer 1 as described above, original 13 placed on the scanner's main body 3 is covered with cover 7 formed of polypropylene or similar flexible material. When cover 7 formed of flexible material is opened, as shown in FIG. 3, cover 7 experiences gravity and thus will flex downward to protrude. As such, as shown in FIG. 4, at an initial stage of closing cover 7 original 13 placed on glass plate 4 will have an end sandwiched between cover 7 and glass plate 4. As a result, if in closing cover 7, wind pressure is caused between cover 7 and the scanner's main body 3, original 13 placed on glass plate 4 will not be displaced from the prescribed position and can reliably be read in.

Furthermore, for scanner equipped printer 1 as described above, cover 7 and guard member 11 are integrated together. This can contribute to a reduced number of components and hence reduced production cost as compared with providing a guard member implemented by a member separate from the cover.

Note that while in the above described embodiment cover 7 is formed of polypropylene by way of example for the sake of illustration, it is not limited thereto and may be formed of other flexible material. Furthermore the present invention has been described as applied to a scanner equipped printer cover 7 may be applied to a scanner having only a scanner function.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A scanner equipped printer comprising:
a main body of the printer printing information of an original;
a main body of said scanner overlying the printer's main body to bear said original thereon to read said information of said original;
a cover provided to said scanner's main body and having one side serving as an axis and the other side pivoted around said axis to be capable of being opened and closed as desired to press downward said original placed on said scanner's main body;
a tray disposed adjacent to said axis and accommodating a sheet to be fed to the printer's main body; and
a guard member provided to said cover to prevent an object placed on said cover from falling toward said tray when said cover is opened, wherein said cover is a flexible member and said cover and said guard member are integrally formed.

2. A scanner comprising:
a main body bearing an original thereon to read information of said original; and
a cover attached to said main body to be capable of being opened and closed as desired to press downward said original placed on said main body, wherein said cover is a flexible member.

3. The scanner according to claim 2, further comprising a main body of a printer underlying the scanner's main body and having a function printing said information of said original.

4. The scanner according to claim 2, further comprising a guard member provided to said cover to prevent an object placed on said cover from falling when said cover is opened.

5. The scanner according to claim 4, further comprising a tray accommodating a sheet to be fed to said printer's main body, wherein said guard member is arranged to prevent an object from falling toward said tray.

6. The scanner according to claim 4, wherein said cover and said guard member are integrally formed.
